(19) United States
(12) Patent Application Publication
(10) Pub. No.: US 2023/0092565 A1
(43) Pub. Date: Mar. 23, 2023

(54) METHOD AND AN APPARATUS FOR CONTROLLING ELEVATOR SYSTEM

(71) Applicant: KONE Corporation, Helsinki (FI)

(72) Inventors: Ari VARELIUS, Helsinki (FI); Antti PERKO, Helsinki (FI); Mika BELOV, Helsinki (FI); Mika KEMPPAINEN, Helsinki (FI); Matti KUJALA, Helsinki (FI); Henry SILVENNOINEN, Helsinki (FI); Antti TUOMINEN, Helsinki (FI)

(73) Assignee: KONE Corporation, Helsinki (FI)

(21) Appl. No.: 17/993,774

(22) Filed: Nov. 23, 2022

Related U.S. Application Data
(63) Continuation of application No. PCT/FI2020/050417, filed on Jun. 12, 2020.

(51) Int. Cl. B66B 1/46; B66B 1/06; B66B 13/14; B66B 1/34

(52) U.S. Cl. CPC B66B 1/468; B66B 1/06; B66B 13/146; B66B 1/3461; B66B 2201/232; B66B 2201/402; B66B 2201/4638; B66B 2201/104; B66B 2201/4646; B66B 2201/242; B66B 2201/405; B66B 2201/4661

(57) ABSTRACT

Vehicle parking information is used to control an elevator system. The vehicle parking information indicates that at least one parking space is occupied, and one or more elements of the elevator system may be controlled based on the vehicle parking information. An apparatus, a method and a computer program are provided.

### TECHNICAL FIELD

The present application relates to the field of elevator systems. In particular, some example embodiments relate to controlling an elevator system.

### BACKGROUND

Buildings may have parking spaces outside as well as inside the building. When a driver arrives at a parking lot, the driver must first find a free parking space, then find an elevator and wait for the elevator to arrive in order to reach his or her destination. This may take a lot of time depending on the size and occupancy level of the parking lot as well as current traffic situation of the elevator system. Furthermore, some users may have special needs which may complicate reaching their destination conveniently after parking.

### SUMMARY

It is an objective to provide a solution for controlling elevator system based on vehicle parking information. Based on the vehicle parking information, for example, requirements and locations of the users may be taken into account together with capacity and estimated traffic of the elevator system to improve elevator service and user experience. The objective is achieved by the features of the independent claims. Some further embodiments are described in the dependent claims.

According to a first aspect, there is provided a method for controlling an elevator system. The method comprises receiving vehicle parking information associated with at least one parking space of a building, the vehicle parking information indicating that the at least one parking space is occupied; and controlling the elevator system based on the vehicle parking information.

In an implementation form of the first aspect, the method comprises determining at least one element of the elevator system to be controlled based on a location of the at least one parking space.

In an implementation form of the first aspect, the method comprises using the vehicle parking information to estimate a walking time to a nearest elevator from the at least one parking space.

In an implementation form of the first aspect, controlling the elevator system based on the vehicle parking information comprises controlling parking of an elevator car in an elevator shaft based on the vehicle parking information.

In an implementation form of the first aspect, controlling parking of an elevator car comprises controlling the parking of the elevator to a floor location having the highest probability for a new elevator call.

In an implementation form of the first aspect, controlling the elevator system based on the vehicle parking information comprises using the vehicle parking information as an indicator of a probable elevator call from a floor associated with the at least one parking space.

In an implementation form of the first aspect, controlling the elevator system based on the vehicle parking information comprises making an elevator call based on the vehicle parking information.

In an implementation form of the first aspect, the method comprises determining a destination floor based on the vehicle parking information, and wherein making an elevator call comprises making a destination call to the destination floor.

In an implementation form of the first aspect, the method comprises determining that the at least one parking space is associated with a predefined user or user category, and wherein controlling the elevator system comprises controlling the elevator system based on the predefined user or user category.

In an implementation form of the first aspect, controlling the elevator system based on the predefined user or user category comprises reserving space from an elevator.

In an implementation form of the first aspect, controlling the elevator system based on the predefined user or user category comprises adjusting elevator door parameters for an elevator trip associated with the specific user or user category.

In an implementation form of the first aspect, controlling the elevator system based on the predefined user or user category comprises enabling at least one of a voice control or a voice guidance for an elevator trip associated with the user or user category.

In an implementation form of the first aspect, the vehicle parking information indicates full occupancy of a parking floor associated with the at least one parking space, and wherein controlling the elevator system based on the vehicle parking information comprises using the vehicle parking information as an indicator that no elevator passenger traffic is expected from an elevator call does not originate from a floor associated with the at least one parking space.

In an implementation form of the first aspect, the elevator system based on the vehicle parking information comprises controlling parking of an elevator car to another floor location than the floor associated with the at least one parking space.

In an implementation form of the first aspect, the vehicle parking information indicates a high arrival rate of vehicles to a specific floor in the building, and wherein the method further comprises taking the high arrival rate of vehicles to the specific floor into account in controlling the elevator system.

According to a second aspect, there is provided an apparatus for controlling an elevator system. The apparatus comprises means for receiving vehicle parking information associated with at least one parking space of a building, the vehicle parking information indicating that the at least one parking space is occupied; and means for controlling the elevator system based on the vehicle parking information.

In an implementation form of the second aspect, the apparatus comprises means for determining at least one element of the elevator system to be controlled based on a location of the at least one parking space.

In an implementation form of the second aspect, the apparatus comprises means for using the vehicle parking information to estimate a walking time to a nearest elevator from the parking space.

In an implementation form of the second aspect, the means for controlling the elevator system based on the vehicle parking information are configured to control parking of an elevator car in an elevator shaft based on the vehicle parking information.

In an implementation form of the second aspect, the means for controlling parking of an elevator car are configured to control the parking of the elevator to a floor location having the highest probability for a new elevator call.

In an implementation form of the second aspect, the means for controlling the elevator system based on the vehicle parking information are configured to use the vehicle parking information as an indicator of a probable elevator call from a floor associated with the at least one parking space.

In an implementation form of the second aspect, the means for controlling the elevator system based on the vehicle parking information are configured to make an elevator call based on the vehicle parking information.

In an implementation form of the second aspect, apparatus comprises means for determining a destination floor based on the vehicle parking information, and wherein the means for making an elevator call are configured to make a destination call to the destination floor.

In an implementation form of the second aspect, the apparatus comprises means for determining that the at least one parking space is associated with a predefined user or user category, and wherein the means for controlling the elevator system are configured to control the elevator system based on the predefined user or user category.

In an implementation form of the second aspect, the means for controlling the elevator system based on the predefined user or user category are configured to reserve space from an elevator.

In an implementation form of the second aspect, the means for controlling the elevator system based on the predefined user or user category are configured to adjust elevator door parameters for an elevator trip associated with the specific user or user category.

In an implementation form of the second aspect the means for controlling the elevator system based on the predefined user or user category are configured to enable at least one of a voice control or a voice guidance for an elevator trip associated with the user or user category.

In an embodiment, in addition or alternatively, the vehicle parking information indicates full occupancy of a parking floor associated with the at least one parking space, and wherein the means for controlling the elevator system based on the vehicle parking information are configured to use the vehicle parking information as an indicator that no elevator passenger traffic is expected from a floor associated with the at least one parking space.

In an implementation form of the second aspect, the means for controlling the elevator system based on the vehicle parking information are configured to control parking of an elevator car to another floor location than the floor associated with the at least one parking space.

In an implementation form of the second aspect, the vehicle parking information indicates a high arrival rate of vehicles to a specific floor in the building, and wherein the apparatus comprises means for taking the high arrival rate of vehicles to the specific floor into account in controlling the elevator system.

According to a third aspect, there is provided an elevator system comprising the apparatus of the second aspect.

According to a fourth aspect, there is provided a computer program comprising program code, which when executed by at least one processing unit, causes the at least one processing unit to perform the method of according to the first aspect.

According to a fifth aspect, there is provided a computer-readable medium comprising a computer program comprising program code, which when executed by at least one processing unit, causes the at least one processing unit to perform the method of the first aspect.

The above discussed means may be implemented, for example, using at least one processor, at least one processor and at least one memory connected to the at least one processor, or at least one processor, at least one memory connected to the at least one processor and an input/output interface connected to the at least one processor.

### BRIEF DESCRIPTION OF THE DRAWINGS

The accompanying drawings, which are included to provide a further understanding of a subject-matter and constitute a part of this specification, illustrate embodiments of the subject-matter and together with the description help to explain the principles of the subject-matter. In the drawings:

FIG. 1 illustrates an apparatus for controlling an elevator system according to an embodiment.

FIG. 2 illustrates an elevator system comprising an apparatus configured to control the elevator system based on the vehicle parking information received from a vehicle parking system according to an embodiment.

FIG. 3A illustrates an example of a first parking floor of a building associated with a vehicle parking management system according to an embodiment.

FIG. 3B illustrates an example of a second parking floor of a building associated with a vehicle parking management system according to an embodiment.

FIG. 4 illustrates an example of a method for controlling an elevator system based on vehicle parking information according to an embodiment.

Like references are used to designate like parts in the accompanying drawings.

### DETAILED DESCRIPTION

Vehicle parking is getting more convenient for users with modern vehicle parking systems. For example, parking spaces may have indicators helping drivers to find a free parking space without a need to circle around a parking lot when searching a free slot. The indicators may be, for example, lamps installed above each parking space which change color form green to red when a sensor associated with the parking space recognizes that a vehicle has parked in the respective parking space. There are also parking space reservation solution showing, for example, with a mobile device application which parking places are taken and which parking spaces are still free. The mobile device application may receive information from a system that receives information from the sensors associated with the parking spaces or update the parking situation based on reservations received from other users via the application. Parking lots may also have a camera surveillance solution which may be automatically monitored or manually monitored by an operator providing updates on the prevailing parking situation. Typically, the parking lots are associated with a building, and the users of the parking spaces may proceed to elevators of the building for their final destination.

According to an embodiment, a method enables controlling an elevator system of a building based on vehicle parking information associated with at least one parking space of the building. The method may be performed, for example, by an apparatus, a controller or an elevator controller. The apparatus or controller may be an internal or an external element of the elevator system. The external element may refer, for example, to a cloud based controller or other controlling entity. The vehicle parking information may indicate that at least one parking space is occupied. The vehicle parking information may further comprise additional information, for example, that the parking space is dedicated to a specific user or user category. The vehicle parking information may be provided as an input for elevator control. This enables a solution in which probable elevator calls may be anticipated and elevators may be controlled accordingly. Further, preferences and needs of the specific users or user categories may be taken into account in the elevator control in response to a parking space associated with the user being occupied. Enhanced service and ease of use of the elevators for the specific users may be provided in a timely manner based on the vehicle parking information.

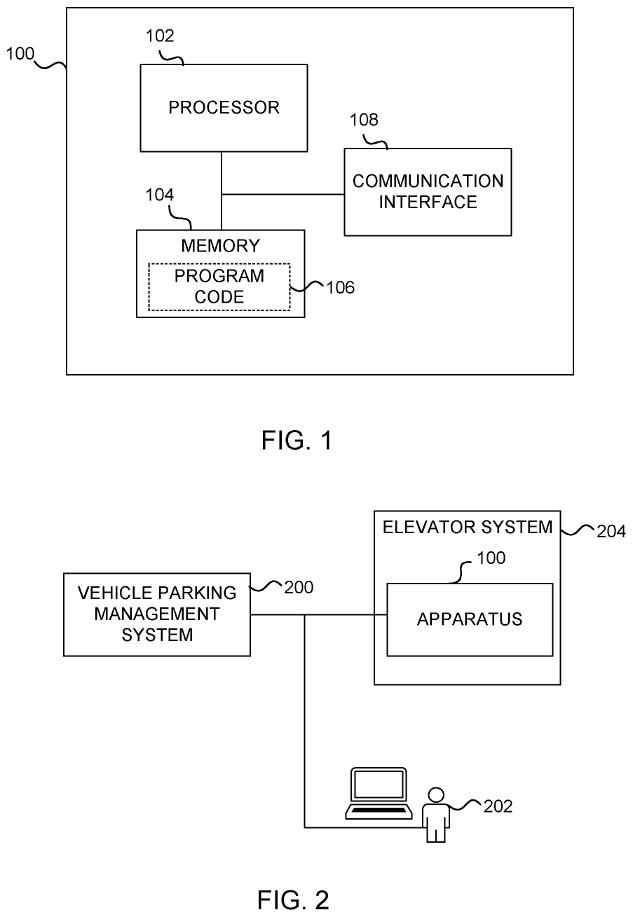

FIG. 1 illustrates an apparatus 100 for controlling an elevator system according to an embodiment. The apparatus 100 may comprise at least one processor 102. The apparatus 100 may further comprise at least one memory 104. The memory 104 may comprise program code 106 which, when executed by the processor 102 causes the apparatus 100 to perform at least one example embodiment. The exemplary embodiments and aspects of the subject-matter can be included within any suitable device, for example, including, servers, elevator controllers, workstations, capable of performing the processes of the exemplary embodiments. The exemplary embodiments may also store information relating to various processes described herein. Although the apparatus 100 is illustrated as a single device it is appreciated that, wherever applicable, functions of the apparatus 100 may be distributed to a plurality of devices.

Example embodiments may be implemented in software, hardware, application logic or a combination of software, hardware and application logic. The example embodiments can store information relating to various methods described herein. This information can be stored in one or more memories 104, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The processor 102 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 104 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The apparatus 100 may comprise a communication interface 108 configured to enable the apparatus 100 to transmit and/or receive information, to/from other apparatuses. The communication interface 108 may be configured to provide at least one of a wireless radio connection, for example, a 3GPP specified mobile broadband connection (e.g. 3G, 4G, 5G), a wireless local area network (WLAN) connection, for example, standardized by IEEE 802.11 series or Wi-Fi alliance, a wired connection, for example, a local area network (LAN) connection, a universal serial bus (USB) connection or an optical network connection, or the like, or a wired Internet connection.

The apparatus 100 comprises means for performing at least one method described herein. In one example, the means may comprise the at least one processor 102, the at least one memory 104 including program code 106 configured to, when executed by the at least one processor 102, cause the apparatus 100 to perform the method.

FIG. 2 illustrates an elevator system 202 comprising the apparatus 100 configured to control the elevator system 200 based on vehicle parking information received from a vehicle parking management system 202 according to an embodiment. The elevator system 204 may comprise one or more elevators or elevator groups. The elevator system 202 and/or the vehicle parking management system 200 may be associated with a specific building, or to a plurality of buildings. The vehicle parking management system 200 may comprise a plurality of parking spaces the occupancy of which is monitored by the vehicle parking management system 200. In an embodiment, each parking space may comprise a sensor configured to indicate whether the parking space is free or occupied. The vehicle parking management system 200 may obtain data from the sensors and monitor the traffic and reservation of the parking spaces. The vehicle parking management system 200 may be configured to communicate with the elevator system 204 or the apparatus 100. The vehicle parking management system 200 may communicate, for example, a location of the sensor indicating an occupied parking space, a specific user or user category associated with the parking space and/or starting time of the parking to the apparatus 100. In an embodiment, the vehicle parking management system 200 may comprise one or more surveillance cameras configured to provide vehicle parking information. In an embodiment, the surveillance cameras may be monitored by an operator 202, and the operator 202 may provide the vehicle parking information to the apparatus 100. For example, the operator 202 may input the vehicle parking information to a building management system comprising the elevator system. The apparatus 100 may receive the vehicle parking information automatically from the vehicle parking management system 200 or as a result to a user input from an operator 202. In another embodiment, the vehicle parking information may be sent from the vehicle parking management system 200 to the elevator system 204 or the apparatus 100 automatically. The apparatus 100 may utilize the received vehicle parking information to control operation of one or more elevators such that a user associated with the at least one occupied parking space may receive convenient elevator service.

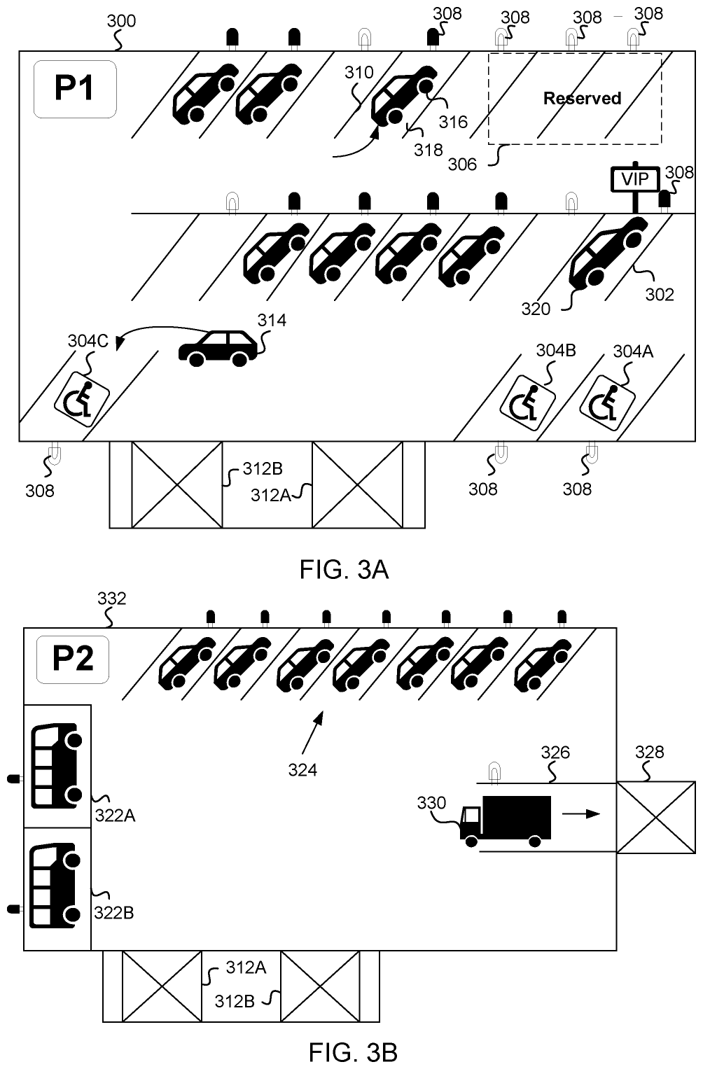

FIG. 3A illustrates an example of a first parking floor 300 of a building associated with a vehicle parking management system according to an embodiment. The first parking floor 300 may comprise a number of parking spaces 302, 304A, 304B, 304C, 306, 310. Each parking space 302, 304A, 304B, 304C, 306, 310 may comprise a sensor 308 configured to indicate reservation state of the parking space 302, 303, 304A, 304B, 304C, 310. The sensors 308 may be coupled with indicators, such as LEDs changing color in response to a vehicle detected by the sensor 308 at the parking space. The LEDs may provide guidance for drivers to find free parking spaces. In FIG. 3A, the reservation state of the parking spaces 302, 304A, 304B, 304C, 306, 310 is indicated with dark colored sensors 308 (occupied) and light colored sensors 308 (free). The sensor data may be stored in the vehicle parking management system 200 and provided for an apparatus 100 configured to control an elevator system of the building. The elevator system may comprise one or more elevators 312A, 312B.

The parking floor 300 may comprise dedicated parking spaces, for example, parking spaces reserved for disabled persons 304A, 304B, 304C and parking spaces reserved for specific users 302, 306. The specific users may comprise, for example, a CEO having an office at the building. The parking floor 300 may also comprise parking spaces 306 reserved for a specific user category, for example, for customers of a car rental company or employees of a company having an office at the building. The specific user category may have, for example, special needs or repetitive habits. The special needs may comprise, for example, requirements typical for disabled persons or personal preferences. The repetitive habits may comprise, for example, a usual destination floor of the user.

The vehicle parking management system 200 may send vehicle parking information each time a state of any of the sensors 308 indicates that a vehicle has parked to a parking space. The vehicle parking information associated with at least one parking space 302, 304A, 304B, 304C, 306, 310 of the building may be received by the apparatus, which may comprise the apparatus 100. The vehicle parking information may indicate that the at least one parking space is occupied. The apparatus may then control the elevator system based on the vehicle parking information. In an embodiment, the apparatus 100 may determine at least one element of the elevator system is to be controlled based on a location of the at least one parking space. The element may be, for example, an elevator car or an elevator parameter. The elevator parameter may be, for example, an elevator car door parameter or an elevator control parameter. The elevator car door parameter may comprise a door time determining for how long the elevator car doors stay open before closing. The elevator control parameter may be associated to, for example, a parking floor of an elevator car, prioritizing an elevator call, initiating an elevator call, initiating a destination call or adjusting elevator traffic forecasts.

For example, a vehicle 314 may have arrived at a parking space for disabled persons 304C. When the vehicle 314 parks at the parking space 304C, the sensor 308 associated with the parking space 304C may transmit data to the vehicle parking management system 200 indicating that the parking space 304C is now reserved. In response, the apparatus 100 may receive the vehicle parking information comprising the reservation data. The reservation data may comprise start time of the parking and location of the parking space 304C. In an embodiment, the vehicle parking information may further comprise additional information associated with the parking space 304C. Alternatively, the vehicle parking information may only comprise the indication that the specific parking space is occupied, and the apparatus 100 may have a stored record comprising the additional information associated with specific parking spaces.

In an embodiment, the additional information may comprise an indication that the parking space is associated with a predefined user category. The predefined user category may comprise a disabled person category. The apparatus may control the elevator system based on the predefined user category. In an embodiment, the apparatus 100 may change elevator door parameters of the elevator which receives an elevator call to the parking floor 300 associated with the parking space 304C. The door parameters may be changed, for example, to extend the time the elevator doors stay open such that the disabled person may have more time to enter and leave the elevator. The apparatus 100 may be configured to switch the door parameters back to the initial door parameters after the user has left the elevator. In an embodiment, the apparatus 100 may initiate at least one of voice control or voice guidance to help visually impaired people use the elevator. The voice control may enable the user to operate the elevator with voice commands. The voice guidance may instruct the user about opening and closing of the elevator car doors, current floor of the elevator, and the destination floor of the elevator. In an embodiment, the apparatus 100 may control passenger capacity of the elevator such that there is sufficient space reserved for the disabled person, possibly using a wheelchair. In an embodiment, the apparatus 100 may control the elevator system based on the vehicle parking information and current elevator traffic situation. The elevator door times may be adjusted only if the prevailing elevator traffic situation allows to do so, e.g. outside peak times of the elevator traffic.

In an embodiment, the vehicle parking information may comprise an estimated walking time to a nearest elevator from the parking space. For example, a second vehicle 316 may have parked to a regular parking space 318 just before the first vehicle 314 arrived at the parking space 304C reserved for disabled persons. The vehicle parking information received by the apparatus 100 may comprise the locations of the parking spaces 304C, 318, start times of parkings and estimated walking times from the parking spaces 304C, 318 to the nearest elevator 312B. Hence, even though the second vehicle 316 arrived first, the apparatus 100 may control the elevator 312B to serve first the user of the first vehicle 314 as the user may reach the elevator 312B first. The estimated walking times associated with each parking space may be received from the vehicle parking management system 200 or stored on the apparatus 100. The walking times may be also estimated by the apparatus based on locations of the parking space and the elevator.

In an embodiment, the apparatus 100 may control parking of an elevator car in an elevator shaft based on the vehicle parking information. For example, based on the two recently reserved parking spaces 304C, 318 at the first parking floor 300, the apparatus 100 may determine that an elevator call is expected from that floor. Hence, the apparatus may control at least one of the elevators 312A, 312B to park to that floor such that there is an elevator waiting for the probable new elevator car call. The vehicle parking information may also indicate that another vehicle has parked in another floor and the apparatus 100 may be configured to park the elevator to the floor associated with an occupied parking space having the shortest estimated walking time to the nearest elevator. The shortest estimated walking time may indicate a highest probability of a new elevator car call. Therefore, elevator traffic may be optimized by estimating probable elevator calls as well as service order of the elevator car calls based on the vehicle parking information.

In general, the vehicle parking information may serve as an indicator of a probable elevator call from a floor associated with the at least one parking space being recently occupied. In an embodiment, the apparatus 100 may be configured to make an elevator call based on the vehicle parking information. This enables a solution in which a waiting time of the elevator may be decreased. The elevator call may be made after a certain threshold. The threshold may be preset, for example, based on an average time it takes for a user to arrive at the elevator from the parking spaces, or the threshold may be determined based on the estimated walking time from the specific parking space to the elevator.

In an embodiment, a vehicle 320 may have parked to a parking space 302 reserved to a specific user. In response, the sensor 308 at the parking space 302 may transmit vehicle parking information associated with the parking space 302 indicating that the parking space is now occupied. The parking space 302 and respective vehicle parking information may be associated with additional information indicating that it is reserved for the specific person. After receiving the vehicle parking information, the apparatus 100 may control the elevator system based on the specific user. In an embodiment, the apparatus 100 may make an elevator call based on the parking information to the floor associated with the parking space 302. In an embodiment, the apparatus 100 may reserve one of the elevators 312A, 312B to serve only this specific user. In an embodiment, the elevator call may comprise making a destination call to a destination floor associated with the specific user.

For example, the specific user may be a chief executive officer (CEO) of a company having headquarters at the building. The CEO may want to have a private elevator to take him/her to the headquarters locating in an upper floor of the building. When the apparatus 100 receives the indication that the parking space 302 of the CEO is occupied, the apparatus 100 may reserve an empty elevator car to pick him/her up from the floor associated with the parking space 302 and take him/her to the floor of the headquarters. In an embodiment, the apparatus 100 may prioritize the elevator call associated with the parking space 302 such that it is served first despite of capacity and current traffic situation of the elevator system. The vehicle parking information may comprise any preferences of the specific user, such as the private elevator ride, fast service, and the destination floor of the specific user. Alternatively, the preferences of the user associated with a dedicated parking space may be stored on the apparatus 100. Control instructions associated with a certain parking space may be also associated with a specific user category. For example, the parking floor 300 may comprise one or more reserved parking spaces 306, for example, to customers or employees of a specific company. The parking spaces 306 may be, for example, associated with a floor of the company as a preset destination floor for an elevator call.

FIG. 3B illustrates an example of a second parking floor 32 of the building associated with the same vehicle parking system and elevator system as illustrated in FIG. 3A. The second parking floor 332 may comprise regular parking spaces 324 and parking spaces dedicated for specific users or user categories 322A, 322B, 326.

The elevator system may further comprise a freight elevator 328. When a vehicle 330 parks at a parking space 326 reserved for loading and unloading goods, the apparatus 100 may make an elevator call to the second parking floor 320 for the freight elevator 328. Hence, the vehicle parking information associated with the parking space 326 may cause the apparatus 100 to control a specific elevator 328 of a plurality of elevators 312A, 312B, 328.

The specific user category may comprise, for example, passengers of buses. The vehicle parking information associated to the parking spaces 322A, 322B reserved for a bus may be used by the apparatus as an indicator that heavy traffic may be expected by the elevators 312A and 312B at the second parking floor 332. The apparatus 100 may be configured to reserve elevator capacity to serve a plurality of passengers based on the vehicle parking information. In an embodiment, the apparatus 100 may control the elevator system to park one or more of the elevators 312A, 312B in an elevator shaft at or close to the second parking floor 332 based on the vehicle parking information associated to the parking space 322A, 322B. Hence, the elevator 312A, 312B may be readily waiting for a probable elevator call from passengers of a bus parked at the parking space 322A, 322B. Alternatively, or in addition, the apparatus 100 may make one or more elevator calls to the second parking floor 332 for the passengers. The building may comprise, for example, a hotel, and the apparatus 100 may make a destination call to a floor where the reception of the hotel locates if the specific user category is associated with new hotel guests.

In an embodiment, the vehicle parking information may indicate full occupancy of the parking floor 332 associated with the at least one parking space 322A, 322B, 324, 326. The apparatus 100 may use the vehicle parking information as an indicator that no elevator passenger traffic is expected from a floor associated with the at least one parking space 322A, 322B, 324, 326. For example, when the elevator 312A, 312B, 328 has served a user associated with the last free parking space at the second parking floor 332, the apparatus 100 may determine that no further elevator calls may be expected from the second parking floor 332 because there are no free parking spaces left. In response to the vehicle parking information indicating that all parking spaces 322A, 322B, 326 of the second parking floor 332 are occupied, the apparatus 100 may control the elevator system to park the elevators to other floors having a higher probability of a new elevator call. This enables a solution in which waiting times for an elevator car may be decreased as the elevator car may already be at the floor from which the next elevator car call may be expected.

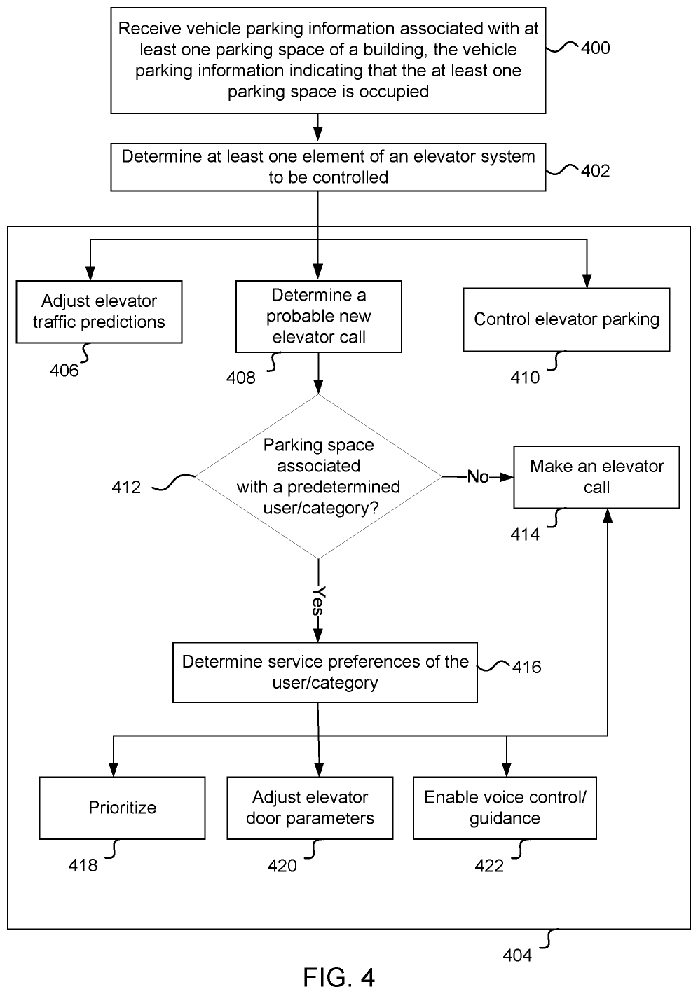

FIG. 4 illustrates a method for controlling an elevator system based on vehicle parking information according to an embodiment. The method may be implemented, for example, by the apparatus 100. The apparatus may be an elevator controller or another controller that may be an internal or an external element of the elevator system. The external element may refer, for example, to a cloud based controller or other controlling entity.

At 400, vehicle parking information associated with at least one parking space of a building is received, the vehicle parking information indicating that the at least one parking space is occupied. The vehicle parking information may be received from an automated vehicle parking management system 200 or an operator 202 of a vehicle parking management system. The vehicle parking management system 200 may have one or more sensors configured to provide information on occupancy of one or more parking spaces of a building.

At 402, at least one element of an elevator system to be controlled may be determined. The at least one element may comprise, for example, a component or a parameter of the elevator system.

At 404, the elevator system is controlled based on the vehicle parking information. Controlling the elevator system may comprise, for example, adjusting elevator traffic predictions based on the vehicle parking information at 406. In an embodiment, the vehicle parking information may comprise an indication that there is a high arrival rate of vehicles to a specific floor in the building. The high arrival rate of vehicles may indicate unexpected or increased traffic to the specific floor. The vehicle parking information may be used to adjust or optimize elevator passenger traffic predictions made based on previous elevator passenger traffic behavior in the building. The vehicle parking information may be used to determine a new input for the predictions such that changes compared to usual elevator traffic may be taken into account in the predictions. Further, the vehicle parking information may be used to anticipate that the next elevator call is coming from the floor associated with the entering vehicle traffic.

At 408, controlling the elevator system may comprise determining a probable new elevator call from a floor associated with the at least one parking space. Based on the vehicle parking information, the number and origin of probable new elevator calls may be estimated to schedule the elevator traffic. In an embodiment, an elevator call may be made based on the vehicle parking information, such that an elevator may be sent in advance to a floor associated with the probable new elevator car. In an embodiment, the vehicle parking information may comprise additional information associated with the parking space indicating a probable destination of the user of the parking space. Hence, a destination call from the floor of the parking space to the destination floor of the user may be made based on the vehicle parking information. The additional information may comprise an estimated walking time to a nearest elevator from the parking space, or a walking time may be estimated based on location of the parking space. The elevator call may be dispatched after a threshold set based on the walking time.

At 410, controlling the elevator system may comprise controlling parking of one or more elevators in one or more elevator shafts. The parking of elevators may be controlled based on the probable new elevator car call such that the elevator is park to the floor from which the elevator car call is expected. In an embodiment, the vehicle parking information comprises an indication that a parking floor associated with the at least one parking space is fully occupied. Based on this it may be determined that no elevator car calls are to be expected from that floor. Hence, it may be determined that elevators are not parked to the fully occupied parking floors, but to other floors having a higher probability of a new elevator car call.

At 412, it may be determined if the parking space is associated with a predefined user or user category. If not, i.e. the parking space is a regular parking space, a normal elevator call may be made to the floor associated with the parking space at 414. If the parking space is associated with a predefined user or user category, preset service preferences associated with the user or user category may be determined at 416. At 418, an elevator or elevator call may be prioritized for the user based on the service preferences. Prioritizing the elevator call may comprise overriding previous elevator calls to serve the user first. Prioritizing the elevator may comprise reserving the whole elevator, or a certain space at the elevator, for the user. In addition, or alternatively, at 420 the service preferences may comprise adjusting elevator door parameters for an elevator trip associated with the user category. In addition, or alternatively, at 422 the service preferences may comprise enabling a voice control and guidance for an elevator trip associated with the user category. The elevator trip may comprise the time from an elevator call until it is estimated that the user has left the elevator. At 414, an elevator call may be made for the specific user or user category based on the service preferences. The service preferences may also comprise a destination floor of the specific user or user category, and the elevator call may comprise a destination call to the destination floor. Hence, the elevator service may be applied in accordance with requirements or preferences of the specific user or user category based on the vehicle parking information.

The method enables using vehicle parking information as an input for elevator control such that the input may be taken into account in controlling elevator traffic and the elevators. For example, elevator calls, specialized service and optimization of elevator traffic may be enabled based on the vehicle parking information. The vehicle parking information may enable providing enhanced elevator service for users with different needs or requirements simply in response to receiving an indication about occupancy of a parking space associated with the user. The method may use information associated to vehicle parking spaces in a novel way to control an elevator system.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method operations which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A method for controlling an elevator system, the method comprising:
receiving vehicle parking information associated with at least one parking space of a building, the vehicle parking information indicating that the at least one parking space is occupied; and
controlling the elevator system based on the vehicle parking information.

2. The method of claim 1, further comprising:
determining at least one element of the elevator system to be controlled based on a location of the at least one parking space.

3. The method of claim 1, further comprising:
using the vehicle parking information to estimate a walking time to a nearest elevator from the at least one parking space.

4. The method of claim 1, wherein controlling the elevator system based on the vehicle parking information comprises:
controlling parking of an elevator car in an elevator shaft based on the vehicle parking information.

5. The method of claim 4, wherein controlling parking of an elevator car comprises controlling the parking of the elevator to a floor location having the highest probability for a new elevator call.

6. The method of claim 1, wherein controlling the elevator system based on the vehicle parking information comprises:
using the vehicle parking information as an indicator of a probable elevator call from a floor associated with the at least one parking space.

7. The method of claim 1, wherein controlling the elevator system based on the vehicle parking information comprises:
making an elevator call based on the vehicle parking information.

8. The method of claim 7, further comprising:
determining a destination floor based on the vehicle parking information, and
wherein making an elevator call comprises making a destination call to the destination floor.

9. The method of claim 1, further comprising:
determining that the at least one parking space is associated with a predefined user or user category, and
wherein controlling the elevator system comprises controlling the elevator system based on the predefined user or user category.

10. The method of claim 9, wherein controlling the elevator system based on the predefined user or user category comprises reserving space from an elevator.

11. The method of claim 9, wherein controlling the elevator system based on the predefined user or user category comprises adjusting elevator door parameters for an elevator trip associated with the specific user or user category.

12. The method of claim 9, wherein controlling the elevator system based on the predefined user or user category comprises enabling at least one of a voice control or a voice guidance for an elevator trip associated with the user or user category.

13. The method of claim 1, wherein the vehicle parking information indicates full occupancy of a parking floor associated with the at least one parking space, and wherein controlling the elevator system based on the vehicle parking information comprises:
using the vehicle parking information as an indicator that no elevator passenger traffic is expected from a floor associated with the at least one parking space.

14. The method of claim 13, wherein controlling the elevator system based on the vehicle parking information comprises controlling parking of an elevator car to another floor location than the floor associated with the at least one parking space.

15. The method of claim 1, wherein the vehicle parking information indicates a high arrival rate of vehicles to a specific floor in the building, and wherein the method further comprises:
taking the high arrival rate of vehicles to the specific floor into account in controlling the elevator system.

16. An apparatus for controlling an elevator system, the apparatus comprising:
means for receiving vehicle parking information associated with at least one parking space of a building, the vehicle parking information indicating that the at least one parking space is occupied; and
means for controlling the elevator system based on the vehicle parking information.

17. The apparatus of claim 16, further comprising:
means for determining at least one element of the elevator system to be controlled based on a location of the at least one parking space.

18. The apparatus of claim 16, further comprising:
means for using the vehicle parking information to estimate a walking time to a nearest elevator from the parking space.

19. The apparatus of claim 16, wherein the means for controlling the elevator system based on the vehicle parking information are configured to control parking of an elevator car in an elevator shaft based on the vehicle parking information.

20. The apparatus of claim 19, wherein the means for controlling parking of an elevator car are configured to control the parking of the elevator to a floor location having the highest probability for a new elevator call.

21. The apparatus of claim 16, wherein the means for controlling the elevator system based on the vehicle parking information are configured to use the vehicle parking information as an indicator of a probable elevator call from a floor associated with the at least one parking space.

22. The apparatus of claim 16, wherein the means for controlling the elevator system based on the vehicle parking information are configured to make an elevator call based on the vehicle parking information.

23. The apparatus of claim 22, further comprising:
means for determining a destination floor based on the vehicle parking information, and
wherein the means for making an elevator call are configured to make a destination call to the destination floor.

24. The apparatus of claim 16, further comprising:
means for determining that the at least one parking space is associated with a predefined user or user category, and
wherein the means for controlling the elevator system are configured to control the elevator system based on the predefined user or user category.

25. The apparatus of claim 24, wherein the means for controlling the elevator system based on the predefined user or user category are configured to reserve space from an elevator.

26. The apparatus of claim 24, wherein the means for controlling the elevator system based on the predefined user or user category are configured to adjust elevator door parameters for an elevator trip associated with the specific user or user category.

27. The apparatus of claim 24, wherein the means for controlling the elevator system based on the predefined user or user category are configured to enable at least one of a voice control or a voice guidance for an elevator trip associated with the user or user category.

28. The apparatus of claim 16, wherein the vehicle parking information indicates full occupancy of a parking floor associated with the at least one parking space, and wherein the means for controlling the elevator system based on the vehicle parking information are configured to use the vehicle parking information as an indicator that no elevator passenger traffic is expected from a floor associated with the at least one parking space.

29. The apparatus of claim 28, wherein the means for controlling the elevator system based on the vehicle parking information are configured to control parking of an elevator car to another floor location than the floor associated with the at least one parking space.

30. The apparatus of claim 16, wherein the vehicle parking information indicates a high arrival rate of vehicles to a specific floor in the building, and wherein the apparatus comprises:
means for taking the high arrival rate of vehicles to the specific floor into account in controlling the elevator system.

31. An elevator system comprising the apparatus of claim 16.

32. A computer program embodied on a non-transitory computer readable medium and comprising program code, which when executed by at least one processing unit, causes the at least one processing unit to perform the method of claim 1.

33. (canceled)
